(19) United States
(12) Patent Application Publication
(10) Pub. No.: US 2008/0024376 A1
(43) Pub. Date: Jan. 31, 2008

(54) ANTENNA ARRANGEMENT

(75) Inventors: Mark Norris, Cambridge (GB); Neil Williams, Cowford (GB); Michael Philippakis, Coombe Surrey (GB)

Correspondence Address: PAUL, HASTINGS, JANOFSKY & WALKER LLP, 875 15th Street, NW, Washington, DC, 20005, US

(73) Assignee: ITI Scotland Limited, Glasgow (GB)

(21) Appl. No.: 11/782,382

(22) Filed: Jul. 24, 2007

(30) Foreign Application Priority Data
Jul. 28, 2006 (GB) 0615148.4

(51) Int. Cl. H01Q 1/44

(52) U.S. Cl. 343/720

(57) ABSTRACT

There is provided an antenna for use in an ultra-wideband device, wherein the antenna is used as an RF radiator and as a heat sink. There is also provided a device for use in an ultra wideband network, the device comprising a component, for example an integrated circuit package, that generates unwanted heat as part of its normal operation, the device further comprising an antenna as described above placed in thermal contact with the component. The antenna may be electrically connected to one or more pins of the component. Alternatively, the antenna may be capacitively connected to the component. There is also provided a heat sink for a wireless communications device, the heat sink being shaped such that it can operate as an antenna for radio frequencies.

### BACKGROUND

1. Field of the Invention

The present invention relates generally to an antenna arrangement for a wireless communication system, and in particular relates to an antenna arrangement for use in an ultra wideband (UWB) wireless communication system.

2. Background of the Invention

Ultra-wideband is a radio technology that transmits digital data across a very wide frequency range, 3.1 to 10.6 GHz. It makes use of ultra low transmission power, typically less than −41 dBm/MHz, so that the technology can literally hide under other transmission frequencies such as existing Wi-Fi, GSM and Bluetooth. This means that ultra-wideband can co-exist with other radio frequency technologies. However, this has the limitation of limiting communication to distances of typically 5 to 20 metres.

There are two approaches to UWB: the time-domain approach, which constructs a signal from pulse waveforms with UWB properties, and a frequency-domain modulation approach using conventional FFT-based Orthogonal Frequency Division Multiplexing (OFDM) over Multiple (frequency) Bands, giving MB-OFDM. Both UWB approaches give rise to spectral components covering a very wide bandwidth in the frequency spectrum, hence the term ultra-wideband, whereby the bandwidth occupies more than 20 percent of the centre frequency, typically at least 500 Mz.

These properties of ultra-wideband, coupled with the very wide bandwidth, mean that UWB is an ideal technology for providing high-speed wireless communication in the home or office environment, whereby the communicating devices are within a range of 20 m of one another.

FIG. 1 shows the arrangement of frequency bands in a Multi Band Orthogonal Frequency Division Multiplexing (MB-OFDM) system for ultra-wideband communication. The MB-OFDM system comprises fourteen sub-bands of 528 MHz each, and uses frequency hopping every 312 ns between sub-bands as an access method. Within each sub-band OFDM and QPSK or DCM coding is employed to transmit data. It is noted that the sub-band around 5 GHz, currently 5.1-5.8 GHz, is left blank to avoid interference with existing narrowband systems, for example 802.11a WLAN systems, security agency communication systems, or the aviation industry.

The fourteen sub-bands are organised into five band groups, four band groups having three 528 MHz sub-bands, and one band group having two 528 MHz sub-bands. As shown in FIG. 1, the first band group comprises sub-band 1, sub-band 2 and sub-band 3. An example UWB system will employ frequency hopping between sub-bands of a band group, such that a first data symbol is transmitted in a first 312.5 ns duration time interval in a first frequency sub-band of a band group, a second data symbol is transmitted in a second 312.5 ns duration time interval in a second frequency sub-band of a band group, and a third data symbol is transmitted in a third 312.5 ns duration time interval in a third frequency sub-band of the band group.

Therefore, during each time interval a data symbol is transmitted in a respective sub-band having a bandwidth of 528 MHz, for example sub-band 2 having a 528 MHz baseband signal centred at 3960 MHz.

There are several designs of antenna that can be used in a UWB device to allow the device to operate across the UWB spectrum. Usually, these antennas are sizeable three-dimensional structures.

The technical properties of ultra-wideband mean that it is being deployed for applications in the field of data communications. For example, a wide variety of applications exist that focus on cable replacement in the following environments:
communication between PCs and peripherals, i.e. external devices such as hard disc drives, CD writers, printers, scanner, etc.
home entertainment, such as televisions and devices that connect by wireless means, wireless speakers, etc.
communication between handheld devices and PCs, for example mobile phones and PDAs, digital cameras and MP3 players, etc.

In addition to an antenna, a UVB device may also include a heat sink in order to dissipate heat generated by one or more of the integrated circuit (IC) packages used in the device. The heat sink usually comprises a metallic three-dimensional structure placed in thermal contact with the IC package(s) that requires heat to be dissipated.

The continuing desire to minimize the size of communications devices is hindered by the need for an antenna and a heat sink.

It is therefore an aim of the invention to provide an antenna and a heat sink for use in a UWB device that occupies less volume than a conventional antenna and heat sink.

### BRIEF SUMMARY OF THE INVENTION

According to a first aspect of the invention, there is provided an antenna for use in a wireless communications device, wherein the antenna is configured such that the antenna is used as a radio frequency radiator and as a heat sink.

By using a combined antenna and beat sink in this way, the invention has the advantage of enabling the size of a communications device to be reduced.

According to another aspect of the invention, there is provided a device for use in a wireless communications network, the device comprising a component that generates unwanted heat as part of its normal operation, the device further comprising an antenna as claimed in any of claims 1 to 7 placed in thermal contact with the component.

According to another aspect of the invention, there is provided a heat sink for use in a wireless communications device, wherein the heat sink is shaped so that it can operate as an antenna for radiating radio frequencies.

According to another aspect of the present invention, there is provided an integrated circuit device for use in a wireless communication system, the integrated circuit device being adapted to mount an antenna as defined in the appended claims.

According to another aspect, the invention relates to the use of an antenna as a heat sink.

### BRIEF DESCRIPTION OF THE DRAWINGS

For a better understanding of the present invention, and to show more clearly how it may be carried into effect, reference will now be made, by way of example only, to the following drawings in which:

FIG. 1 shows the multi-band OFDM alliance (MBOA) approved frequency spectrum of a MB-OFDM system;

FIG. 2 shows a perspective view of an exemplary ultra-wideband antenna in accordance with the invention;

FIG. 3 shows an exemplary antenna element used to form the ultra-wideband antenna of FIG. 2;

FIG. 4 shows the antenna of FIG. 2 attached to an integrated circuit in accordance with one embodiment of the invention; and

FIG. 5 shows the antenna of FIG. 2 attached to an integrated circuit in accordance with a second embodiment of the invention.

### DETAILED DESCRIPTION OF THE INVENTION

Although the invention will be described further herein as being adapted for use in an ultra wideband network, it will be appreciated that the invention can be adapted for use in other types of network.

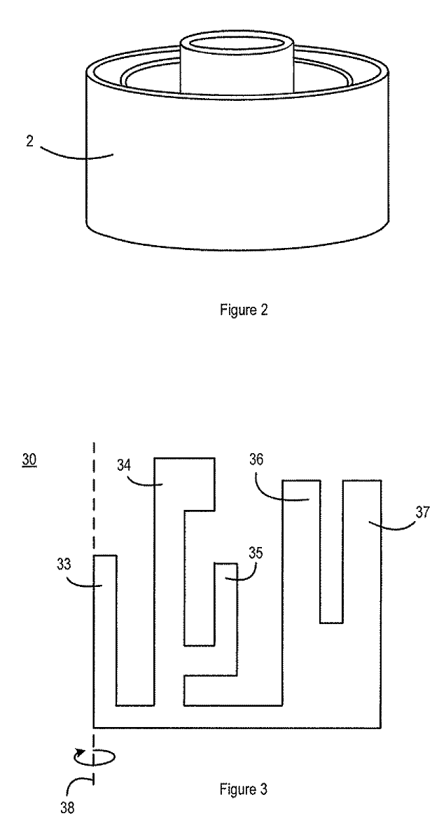

FIGS. 2 and 3 show an exemplary omni-directional ultra-wideband antenna 2 in accordance with the invention. The antenna 2 is formed as a three-dimensional structure, and is formed as a cast or extruded metal construction. However, it will be appreciated that the antenna 2 can be formed from other suitable material. FIG. 3 shows an antenna element used to form the exemplary antenna 2. Preferably, the antenna element comprises a meander-line structure 30, which includes a plurality of fins 33, 34, 35, 36 and 37. It will be appreciated that other configurations of fins can be used in an antenna in accordance with the invention.

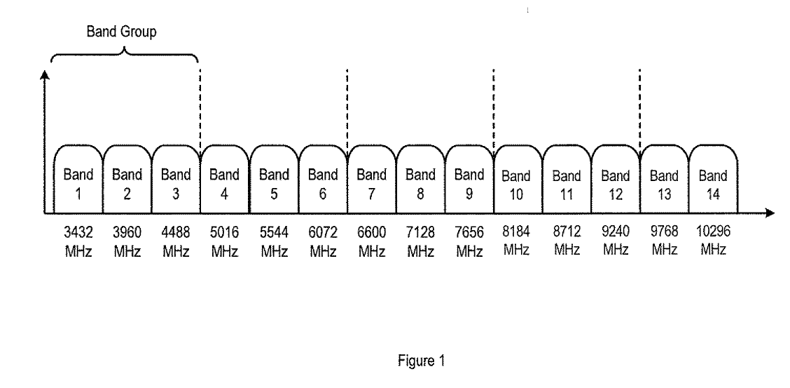

The three-dimensional antenna 2 may be formed by rotating the meander-line structure 30 shown in FIG. 3 around an axis 38 parallel to the left-hand edge of the meander-line structure 30. The antenna 2 is suitable for use in an ultra-wideband network, and in particular is suitable for use across the frequency range of approximately 3 GHz to 10 GHz, or that coinciding with the full ultra wideband bandwidth, as shown in FIG. 1. Thus, the length of the longest fin, fin 34, is approximately 25 mm, which is one-quarter of the wavelength of a signal at 3 GHz. It will be appreciated, however, that the precise details of the meander-line structure 30 will depend on the wireless communications system in which the antenna is designed to operate, and variations of the meander-line structure shown in FIG. 3 are therefore possible.

It is noted that such an antenna 2 is structurally similar to heat sinks used to dissipate heat from electronic components. Therefore, in accordance with the invention, the antenna 2 is used for simultaneously radiating RF signals and dissipating heat from an electronic component in a UWB device. This provides the advantage that a separate antenna and heat sink is not required, thereby enabling the size of the device to be reduced. The invention further results in a reduction of the cost of manufacturing the UWB device.

The antenna 2 shown in FIG. 2 may also comprise a monopole antenna element (not shown) arranged in the centre of the antenna. Such a monopole antenna element may be used in conjunction with the meander line structure for controlling the radiating properties of the antenna 2.

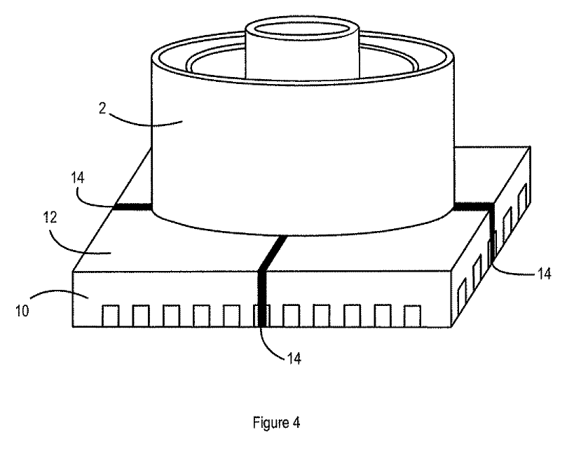

FIG. 4 shows the antenna 2 connected to an integrated circuit package 10 in accordance with an exemplary embodiment of the invention. Although the invention is described below with reference to an integrated circuit package, it will be appreciated that the antenna 2 can be used to dissipate heat from any type of electrical component in a UWB device that generates unwanted heat as part of its normal operation.

The antenna 2 is connected to the integrated circuit package 10 such that heat can be conducted from the integrated circuit package 10 to the antenna 2, where it is radiated into the atmosphere or the inside of the UWB device. Preferably, the antenna 2 is thermally connected directly to an upper surface 12 of the integrated circuit package 10. The antenna 2 can be connected to the upper surface 12 of the integrated circuit package 10 via heat-sinking paste or adhesive, in order to improve the transfer of heat from the integrated circuit package 10 to the antenna 2.

In an embodiment of the invention in which the integrated circuit package 10 generates the RF excitation signals for the antenna 2, the feedpoint of the antenna 2 can be connected directly to pins 14 of the integrated circuit 10. This provides the advantage that as the RF connection between the integrated circuit package 10 and the antenna 2 is shorter than in a conventional UWB device, the RF loss from the connection is reduced.

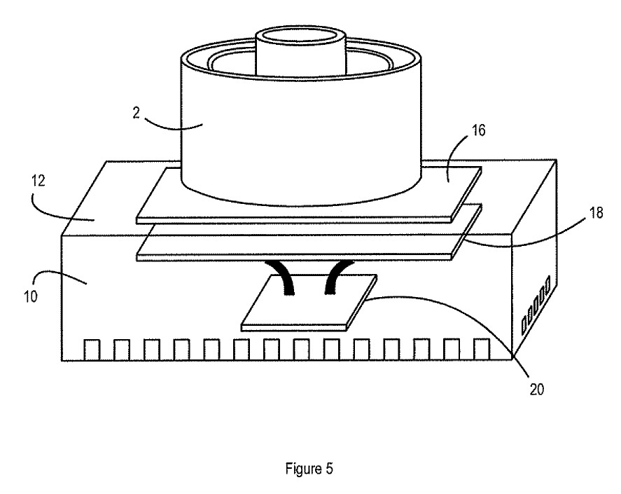

As an alternative to directly connecting the antenna 2 to the pins 14 of the integrated circuit package 10, the antenna 2 may be capacitively coupled to the integrated circuit package 10. This is illustrated in the embodiment of FIG. 5. According to this embodiment, the antenna 2 is provided with a capacitive plate 16 at its feedpoint and the integrated circuit package 10 comprises an internal capacitive plate 18 located beneath the upper surface 12 of the integrated circuit package 10. The internal capacitive plate 18 is connected to an integrated circuit die 20 which generates the RF excitation signals for the antenna 2. The external capacitive plate 16 is located directly above the internal capacitive plate 18 so that the antenna 2 is capacitively coupled to the integrated circuit die 20.

It will be appreciated by a person skilled in the art that, during the manufacture of integrated circuit packages, the internal structure of an integrated package is arranged such that a heat element or “slug” is incorporated to conduct excess heat energy, thereby improving the thermal performance of the package. The heat element or “slug” is typically built into the base of the package. It is noted that such a heat element or “slug” may be used to conduct RF energy to the external heat sink while maintaining the electrical isolation required to ensure proper operation of the circuit.

It is also noted that the invention may be used in “flip-chip” packaging technology which is adapted to incorporate the above described connection within the manufacturing process.

There is therefore provided an antenna for use in an ultra-wideband device which can also be used as a heat sink, resulting in a reduction in size of the internal components in the ultra-wideband device.

As mentioned above, in the case where the heat generating circuit also generates the RF energy, the mounting of the antenna directly against the integrated circuit also has the advantage of reducing the length of the RF connection between the integrated circuit and the antenna, thereby reducing RF losses at these frequencies.

Although the embodiments of FIGS. 4 and 5 show the combined antenna and heat sink being connected directly to a device which both dissipates heat and emits the RF radiation, it will be appreciated that heat may be dissipated from any component within the UIWB device, and is not restricted to the device providing the RF signals for the antenna. This permits, for example, the dissipation of heat from a processor device while simultaneously receiving or transmitting RF energy from an adjacent or nearby device. In other words, an excitation signal for the antenna can be provided by a separate, different to the component that is in thermal contact with the antenna.

It will be appreciated that although the preferred embodiments of the invention make reference to a meander-line antenna, other types of antenna can also be used without departing from the scope of the invention as defined by the appended claims. In other words, other three-dimensional finned structures are also possible without rotating a meander-line, for example a hedgehog style finned structure. In addition, although the preferred embodiment relates to a three-dimensional antenna, the invention may also be used with an antenna having a two-dimensional structure, for example a bow-tie antenna.

Although the antenna in the preferred embodiments as been described as operating in the 3 to 10 GHz frequency range, it will be appreciated that the antenna may be configured to operate at any frequency range. The antenna can also be used to transmit and/or receive signals.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim and “a” or “an” does not exclude a plurality. Any reference signs in the claims shall not be construed so as to limit their scope.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. An antenna for use in a wireless communications system, wherein the antenna is configured such that the antenna is used as a radio frequency radiator and as a heat sink.

2. An antenna as claimed in claim 1, wherein the antenna is suitable for use across a frequency range of approximately 3 GHz to 10 GHz, or that coinciding with the full ultra wideband bandwidth.

3. An antenna as claimed in claim 1, wherein the antenna comprises a three-dimensional structure.

4. An antenna as claimed in claim 3, wherein the antenna comprises a finned three-dimensional structure.

5. An antenna as claimed in claim 4, wherein the antenna is formed from a meander-line structure.

6. An antenna as claimed in claim 5, wherein the meander-line structure comprises a plurality of fins.

7. An antenna as claimed in claim 6, wherein at least one fin has a length that is different to the length of the other fins.

8. An antenna as claimed in claim 7, wherein the longest fin is approximately 25 mm in length.

9. An antenna as claimed in claim 1, further comprising a capacitive plate for receiving excitation signals from a component in the wireless communications system.

10. An antenna as claimed in claim 1, wherein the communications system is an ultra-wideband communications system.

11. A device for use in a wireless communications system, the device comprising a component that generates unwanted heat as part of its normal operation, the device further comprising an antenna as claimed in claim 1 placed in thermal contact with the component.

12. A device as claimed in claim 11, wherein the antenna is attached directly to a surface of the component.

13. A device as claimed in claim 11, wherein the antenna is attached to the component using heat-sinking paste or adhesive.

14. A device as claimed in claim 11, wherein the component comprises an integrated circuit package or system assembly.

15. A device as claimed in claim 14, wherein the integrated circuit package provides the excitation signals for the antenna.

16. A device as claimed in claim 15, wherein the antenna is electrically connected to one or more pins of the integrated circuit package.

17. A device as claimed in claim 15, wherein the antenna is capacitively coupled to the integrated circuit package.

18. A device as claimed in claim 17, wherein the integrated circuit package comprises an internal capacitive plate located beneath an upper surface of the integrated circuit package, and the antenna comprises an external capacitive plate in electrical contact with the antenna.

19. A device as claimed in claim 11, wherein an excitation signal for the antenna is provided by a separate component, different to the component that is in thermal contact with the antenna.

20. A device as claimed in claim 11, wherein the communications system is an ultra-wideband communications system.

21. An integrated circuit device for use in a wireless communication system, the integrated circuit device being adapted to mount an antenna as defined in claim 1.

22. A heat sink for use in a wireless communications device, wherein the heat sink is shaped so that it can operate as an antenna for radiating radio frequencies.

23. The use of an antenna as a heat sink.

24. An antenna as hereinbefore described, with reference to, and as illustrated in FIGS. 2 to 5 of the accompanying drawings.
